(19) United States
(12) Patent Application Publication
(10) Pub. No.: US 2026/0212156 A1
(43) Pub. Date: Jul. 23, 2026

(54) System, Method, and Computer Program Product for Efficient Node Embeddings for Use in Predictive Models

(71) Applicant: Visa International Service Association, San Francisco, CA (US)

(72) Inventors: Huiyuan Chen, San Jose, CA (US); Fei Wang, Fremont, CA (US); Hao Yang, San Jose, CA (US)

(21) Appl. No.: 19/144,566

(22) PCT Filed: Jan. 2, 2024
(86) PCT No.: PCT/US2024/010026

§ 371 Date: Jun. 30, 2025

Related U.S. Application Data
(60) Provisional application No. 63/436,787, filed on Jan. 3, 2023.

(51) Int. Cl. G06N 3/042; G06N 3/045; G06N 3/08

(52) U.S. Cl. CPC G06N 3/042; G06N 3/045; G06N 3/08

(57) ABSTRACT

Described are a system, method, and computer program product for efficient node embeddings for use in predictive models. The method includes receiving graph data associated with a graph comprising a plurality of nodes associated with a plurality of entities and a plurality of edges associated with interactions between entities. The method also includes generating a plurality of node embeddings for the plurality of nodes, and generating a matrix based on each positive pair of nodes and the plurality of node embeddings. The method further includes decomposing the matrix to provide a left unitary matrix, a diagonal matrix, and a right unitary matrix. The method further includes determining a plurality of updated node embeddings for the plurality of nodes based on the left unitary matrix and the diagonal matrix. The method further includes communicating the plurality of updated node embeddings for inputting into a machine learning model to generate a prediction.

### CROSS REFERENCE TO RELATED APPLICATIONS

This application is the United States national phase of International Application No. PCT/US24/10026, filed Jan. 2, 2024, and claims priority to U.S. Provisional Patent Application No. 63/436,787, filed Jan. 3, 2023, the disclosures of which are hereby incorporated by reference in their entireties.

### BACKGROUND

### 1. Technical Field

This disclosure relates generally to decision systems and, in non-limiting embodiments or aspects, to systems, methods, and computer program products for determining node embeddings for use in predictive models more quickly and with less memory.

### 2. Technical Considerations

A system may need to analyze interactions (e.g., relationships, transactions, communications, etc.) between entities in a network. For transaction service providers, networks may include billions of entities having interactions with other entities, and the number of interactions may be of a same or even greater scale than the number of entities. There is a need for entity-entity interactions to be accounted for and used as input to predictive models, such as to train the predictive models to categorize entities in a network as being similar or dissimilar. For networks including electronic payment processing networks, known interactions and entities will further grow over time, exacerbating time (e.g., computer processing time) and size (e.g., long- or short-term computer memory) concerns. Generating representations of the interactions between entities in a network may be computationally time-intensive, and allocations of computer memory at the time a prediction is needed may be excessive and infeasible for certain applications.

There is a need in the art for a technical solution for efficiently producing node embeddings of graph-based entity interactions for use as input in predictive models to reduce computing resource requirements.

### SUMMARY

According to some non-limiting embodiments or aspects, provided are systems, methods, and computer program products for efficient node embeddings for use in predictive models (e.g., that overcome some or all of the deficiencies identified above).

According to some non-limiting embodiments or aspects, provided is a computer-implemented method for efficient node embeddings for use in predictive models. The method includes receiving, with at least one processor, graph data associated with a graph including a plurality of nodes and a plurality of edges, each node of the plurality of nodes associated with an entity of a plurality of entities, each edge of the plurality of edges associated with an interaction between at least two of the plurality of entities, the graph including a plurality of positive pairs of nodes, each respective positive pair of nodes including a respective pair of nodes of the plurality of nodes connected by a respective edge of the plurality of edges. The method also includes generating, with at least one processor, a plurality of node embeddings including a node embedding for each node of the plurality of nodes based on the graph data. The method further includes generating, with at least one processor, a matrix based on each positive pair of nodes of the plurality of positive pairs of nodes and the plurality of node embeddings. The method further includes decomposing, with at least one processor, the matrix to provide a left unitary matrix, a diagonal matrix, and a right unitary matrix. The method further includes determining, with at least one processor, a plurality of updated node embeddings including an updated node embedding for each node of the plurality of nodes based on the left unitary matrix and the diagonal matrix. The method further includes communicating, with at least one processor, the plurality of updated node embeddings for inputting into at least one machine learning model to generate at least one prediction.

In some non-limiting embodiments or aspects, the graph data may include at least one of an adjacency matrix, a degree matrix, or any combination thereof.

In some non-limiting embodiments or aspects, generating the plurality of node embeddings may include generating the plurality of node embeddings based on randomized matrix factorization.

In some non-limiting embodiments or aspects, generating the plurality of node embeddings may include determining a plurality of initial node embeddings including an initial node embedding for each node of the plurality of nodes based on the graph data, wherein the plurality of node embeddings includes the plurality of initial node embeddings.

In some non-limiting embodiments or aspects, generating the plurality of node embeddings may include determining, with at least one processor, a plurality of initial node embeddings including an initial node embedding for each node of the plurality of nodes based on the graph data. Generating the plurality of node embeddings may also include training, with at least one processor, at least one graph neural network based on the plurality of initial node embeddings to provide at least one set of node embeddings. The plurality of node embeddings may include a set of node embeddings of the at least one set of node embeddings.

In some non-limiting embodiments or aspects, the at least one graph neural network may include at least one hidden layer graph neural network and at least one final layer graph neural network. Training the at least one graph neural network may include training, with at least one processor, the at least one hidden layer graph neural network based on the plurality of initial node embeddings to provide at least one set of hidden layer node embeddings. Training the at least one graph neural network may also include training, with at least one processor, the at least one final layer graph neural network based on the at least one set of hidden layer node embeddings to provide a set of final layer node embeddings. The set of node embeddings may include the set of final layer node embeddings.

In some non-limiting embodiments or aspects, the graph may include a plurality of negative pairs of nodes, wherein each respective negative pair of nodes includes a respective pair of nodes of the plurality of nodes that are not connected by an edge of the plurality of edges. Generating the matrix may include generating, with at least one processor, the matrix based on each positive pair of nodes of the plurality of positive pairs of nodes, each negative pair of nodes of the plurality of negative pairs of nodes, and the plurality of node embeddings.

In some non-limiting embodiments or aspects, generating the matrix may include generating, with at least one processor, the matrix based on each positive pair of nodes of the plurality of positive pairs based on a first probability value associated with a likelihood of an association between nodes of each positive pair of nodes. Generating the matrix may also include generating, with at least one processor, the matrix based on each negative pair of nodes of the plurality of negative pairs of nodes based on a second probability value associated with a likelihood of a disassociation between nodes of each negative pair of nodes.

In some non-limiting embodiments or aspects, generating the matrix based on each negative pair of nodes of the plurality of negative pairs of nodes using the second probability value may include regularizing the second probability value using a hyperparameter that attenuates an influence of the second probability value.

In some non-limiting embodiments or aspects, the matrix may be based on a partial derivative of a loss function with respect to an embedding of a first node and an embedding of a second node in each positive pair of nodes of the plurality of positive pairs.

In some non-limiting embodiments or aspects, decomposing the matrix may include decomposing, with at least one processor, the matrix based on at least one of an eigendecomposition technique, a native singular value decomposition (SVD) technique, a fast SVD technique, or any combination thereof.

In some non-limiting embodiments or aspects, the method may further include determining a plurality of higher-order node embeddings based on an inverse of the degree matrix, the adjacency matrix, a Laplacian matrix of the adjacency matrix, and the updated node embedding for at least one node of the plurality of nodes.

According to some non-limiting embodiments or aspects, provided is a system for efficient node embeddings for use in predictive models. The system includes at least one processor configured to receive graph data associated with a graph including a plurality of nodes and a plurality of edges, each node of the plurality of nodes associated with an entity of a plurality of entities, each edge of the plurality of edges associated with an interaction between at least two of the plurality of entities, the graph including a plurality of positive pairs of nodes, each respective positive pair of nodes including a respective pair of nodes of the plurality of nodes connected by a respective edge of the plurality of edges. The system also includes at least one processor configured to generate a plurality of node embeddings including a node embedding for each node of the plurality of nodes based on the graph data. The system further includes at least one processor configured to generate a matrix based on each positive pair of nodes of the plurality of positive pairs of nodes and the plurality of node embeddings. The system further includes at least one processor configured to decompose the matrix to provide a left unitary matrix, a diagonal matrix, and a right unitary matrix. The system further includes at least one processor configured to determine a plurality of updated node embeddings including an updated node embedding for each node of the plurality of nodes based on the left unitary matrix and the diagonal matrix. The system further includes at least one processor configured to communicate the plurality of updated node embeddings for inputting into at least one machine learning model to generate at least one prediction.

In some non-limiting embodiments or aspects, when generating the plurality of node embeddings, the at least one processor may be configured to determine a plurality of initial node embeddings including an initial node embedding for each node of the plurality of nodes based on the graph data. When generating the plurality of node embeddings, the at least one processor may also be configured to train at least one graph neural network based on the plurality of initial node embeddings to provide at least one set of node embeddings. The plurality of node embeddings may include a set of node embeddings of the at least one set of node embeddings.

In some non-limiting embodiments or aspects, the at least one graph neural network may include at least one hidden layer graph neural network and at least one final layer graph neural network. When training the at least one graph neural network, the at least one processor may be configured to train the at least one hidden layer graph neural network based on the plurality of initial node embeddings to provide at least one set of hidden layer node embeddings. When training the at least one graph neural network, the at least one processor may also be configured to train the at least one final layer graph neural network based on the at least one set of hidden layer node embeddings to provide a set of final layer node embeddings. The set of node embeddings may include the set of final layer node embeddings.

In some non-limiting embodiments or aspects, the graph may include a plurality of negative pairs of nodes, wherein each respective negative pair of nodes includes a respective pair of nodes of the plurality of nodes that are not connected by an edge of the plurality of edges. When generating the matrix, the at least one processor may be configured to generate the matrix based on each positive pair of nodes of the plurality of positive pairs of nodes, each negative pair of nodes of the plurality of negative pairs of nodes, and the plurality of node embeddings.

According to some non-limiting embodiments or aspects, provided is a computer program product for efficient node embeddings for use in predictive models. The computer program product includes at least one non-transitory computer-readable medium including one or more instructions that, when executed by at least one processor, cause the at least one processor to receive graph data associated with a graph including a plurality of nodes and a plurality of edges, each node of the plurality of nodes associated with an entity of a plurality of entities, each edge of the plurality of edges associated with an interaction between at least two of the plurality of entities, the graph including a plurality of positive pairs of nodes, each respective positive pair of nodes including a respective pair of nodes of the plurality of nodes connected by a respective edge of the plurality of edges. The one or more instructions also cause the at least one processor to generate a plurality of node embeddings including a node embedding for each node of the plurality of nodes based on the graph data. The one or more instructions further cause the at least one processor to generate a matrix based on each positive pair of nodes of the plurality of positive pairs of nodes and the plurality of node embeddings. The one or more instructions further cause the at least one processor to decompose the matrix to provide a left unitary matrix, a diagonal matrix, and a right unitary matrix. The one or more instructions further cause the at least one processor to determine a plurality of updated node embeddings including an updated node embedding for each node of the plurality of nodes based on the left unitary matrix and the diagonal matrix. The one or more instructions further cause the at least one processor to communicate the plurality of updated node embeddings for inputting into at least one machine learning model to generate at least one prediction.

In some non-limiting embodiments or aspects, the one or more instructions that cause the at least one processor to generate the plurality of node embeddings may cause the at least one processor to determine a plurality of initial node embeddings including an initial node embedding for each node of the plurality of nodes based on the graph data. The one or more instructions that cause the at least one processor to generate the plurality of node embeddings may also cause the at least one processor to train at least one graph neural network based on the plurality of initial node embeddings to provide at least one set of node embeddings. The plurality of node embeddings may include a set of node embeddings of the at least one set of node embeddings.

In some non-limiting embodiments or aspects, the at least one graph neural network may include at least one hidden layer graph neural network and at least one final layer graph neural network. The one or more instructions that cause the at least one processor to train the at least one graph neural network may cause the at least one processor to train the at least one hidden layer graph neural network based on the plurality of initial node embeddings to provide at least one set of hidden layer node embeddings. The one or more instructions that cause the at least one processor to train the at least one graph neural network may also cause the at least one processor to train the at least one final layer graph neural network based on the at least one set of hidden layer node embeddings to provide a set of final layer node embeddings. The set of node embeddings may include the set of final layer node embeddings.

In some non-limiting embodiments or aspects, the graph may include a plurality of negative pairs of nodes. Each respective negative pair of nodes may include a respective pair of nodes of the plurality of nodes that are not connected by an edge of the plurality of edges. The one or more instructions that cause the at least one processor to generate the matrix may cause the at least one processor to generate the matrix based on each positive pair of nodes of the plurality of positive pairs of nodes, each negative pair of nodes of the plurality of negative pairs of nodes, and the plurality of node embeddings.

Further non-limiting embodiments or aspects will be set forth in the following numbered clauses:
Clause 1: A computer-implemented method comprising: receiving, with at least one processor, graph data associated with a graph comprising a plurality of nodes and a plurality of edges, each node of the plurality of nodes associated with an entity of a plurality of entities, each edge of the plurality of edges associated with an interaction between at least two of the plurality of entities, the graph comprising a plurality of positive pairs of nodes, each respective positive pair of nodes comprising a respective pair of nodes of the plurality of nodes connected by a respective edge of the plurality of edges; generating, with at least one processor, a plurality of node embeddings comprising a node embedding for each node of the plurality of nodes based on the graph data; generating, with at least one processor, a matrix based on each positive pair of nodes of the plurality of positive pairs of nodes and the plurality of node embeddings; decomposing, with at least one processor, the matrix to provide a left unitary matrix, a diagonal matrix, and a right unitary matrix; determining, with at least one processor, a plurality of updated node embeddings comprising an updated node embedding for each node of the plurality of nodes based on the left unitary matrix and the diagonal matrix; and communicating, with at least one processor, the plurality of updated node embeddings for inputting into at least one machine learning model to generate at least one prediction.
Clause 2: The method of clause 1, wherein the graph data comprises at least one of an adjacency matrix, a degree matrix, or any combination thereof.
Clause 3: The method of clause 1 or clause 2, wherein generating the plurality of node embeddings comprises generating the plurality of node embeddings based on randomized matrix factorization.
Clause 4: The method of any of clauses 1-3, wherein generating the plurality of node embeddings comprises determining a plurality of initial node embeddings comprising an initial node embedding for each node of the plurality of nodes based on the graph data, wherein the plurality of node embeddings comprises the plurality of initial node embeddings.
Clause 5: The method of any of clauses 1-4, wherein generating the plurality of node embeddings comprises: determining, with at least one processor, a plurality of initial node embeddings comprising an initial node embedding for each node of the plurality of nodes based on the graph data; and training, with at least one processor, at least one graph neural network based on the plurality of initial node embeddings to provide at least one set of node embeddings, wherein the plurality of node embeddings comprises a set of node embeddings of the at least one set of node embeddings.
Clause 6: The method of any of clauses 1-5, wherein the at least one graph neural network comprises at least one hidden layer graph neural network and at least one final layer graph neural network, and wherein training the at least one graph neural network comprises: training, with at least one processor, the at least one hidden layer graph neural network based on the plurality of initial node embeddings to provide at least one set of hidden layer node embeddings; and training, with at least one processor, the at least one final layer graph neural network based on the at least one set of hidden layer node embeddings to provide a set of final layer node embeddings, wherein the set of node embeddings comprises the set of final layer node embeddings.
Clause 7: The method of any of clauses 1-6, wherein the graph comprises a plurality of negative pairs of nodes, wherein each respective negative pair of nodes comprises a respective pair of nodes of the plurality of nodes that are not connected by an edge of the plurality of edges, and wherein generating the matrix comprises: generating, with at least one processor, the matrix based on each positive pair of nodes of the plurality of positive pairs of nodes, each negative pair of nodes of the plurality of negative pairs of nodes, and the plurality of node embeddings.
Clause 8: The method of any of clauses 1-7, wherein generating the matrix comprises: generating, with at least one processor, the matrix based on each positive pair of nodes of the plurality of positive pairs of nodes based on a first probability value associated with a likelihood of an association between nodes of each positive pair of nodes; and generating, with at least one processor, the matrix based on each negative pair of nodes of the plurality of negative pairs of nodes based on a second probability value associated with a likelihood of a disassociation between nodes of each negative pair of nodes.
Clause 9: The method of any of clauses 1-8, wherein generating the matrix based on each negative pair of nodes of the plurality of negative pairs of nodes using the second probability value comprises: regularizing the second probability value using a hyperparameter that attenuates an influence of the second probability value.
Clause 10: The method of any of clauses 1-9, wherein the matrix is based on a partial derivative of a loss function with respect to an embedding of a first node and an embedding of a second node in each positive pair of nodes of the plurality of positive pairs of nodes.
Clause 11: The method of any of clauses 1-10, wherein decomposing the matrix comprises: decomposing, with at least one processor, the matrix based on at least one of an eigendecomposition technique, a native singular value decomposition (SVD) technique, a fast SVD technique, or any combination thereof.
Clause 12: The method of any of clauses 1-11, further comprising: determining a plurality of higher-order node embeddings based on an inverse of the degree matrix, the adjacency matrix, a Laplacian matrix of the adjacency matrix, and the updated node embedding for at least one node of the plurality of nodes.
Clause 13: A system comprising at least one processor configured to: receive graph data associated with a graph comprising a plurality of nodes and a plurality of edges, each node of the plurality of nodes associated with an entity of a plurality of entities, each edge of the plurality of edges associated with an interaction between at least two of the plurality of entities, the graph comprising a plurality of positive pairs of nodes, each respective positive pair of nodes comprising a respective pair of nodes of the plurality of nodes connected by a respective edge of the plurality of edges; generate a plurality of node embeddings comprising a node embedding for each node of the plurality of nodes based on the graph data; generate a matrix based on each positive pair of nodes of the plurality of positive pairs of nodes and the plurality of node embeddings; decompose the matrix to provide a left unitary matrix, a diagonal matrix, and a right unitary matrix; determine a plurality of updated node embeddings comprising an updated node embedding for each node of the plurality of nodes based on the left unitary matrix and the diagonal matrix; and communicate the plurality of updated node embeddings for inputting into at least one machine learning model to generate at least one prediction.
Clause 14: The system of clause 13, wherein, when generating the plurality of node embeddings, the at least one processor is configured to: determine a plurality of initial node embeddings comprising an initial node embedding for each node of the plurality of nodes based on the graph data; and train at least one graph neural network based on the plurality of initial node embeddings to provide at least one set of node embeddings, wherein the plurality of node embeddings comprises a set of node embeddings of the at least one set of node embeddings.
Clause 15: The system of clause 13 or clause 14, wherein the at least one graph neural network comprises at least one hidden layer graph neural network and at least one final layer graph neural network, and wherein, when training the at least one graph neural network, the at least one processor is configured to: train the at least one hidden layer graph neural network based on the plurality of initial node embeddings to provide at least one set of hidden layer node embeddings; and train the at least one final layer graph neural network based on the at least one set of hidden layer node embeddings to provide a set of final layer node embeddings, wherein the set of node embeddings comprises the set of final layer node embeddings.
Clause 16: The system of any of clauses 13-15, wherein the graph comprises a plurality of negative pairs of nodes, wherein each respective negative pair of nodes comprises a respective pair of nodes of the plurality of nodes that are not connected by an edge of the plurality of edges, and wherein, when generating the matrix, the at least one processor is configured to: generate the matrix based on each positive pair of nodes of the plurality of positive pairs of nodes, each negative pair of nodes of the plurality of negative pairs of nodes, and the plurality of node embeddings.
Clause 17: A computer program product comprising at least one non-transitory computer-readable medium comprising one or more instructions that, when executed by at least one processor, cause the at least one processor to: receive graph data associated with a graph comprising a plurality of nodes and a plurality of edges, each node of the plurality of nodes associated with an entity of a plurality of entities, each edge of the plurality of edges associated with an interaction between at least two of the plurality of entities, the graph comprising a plurality of positive pairs of nodes, each respective positive pair of nodes comprising a respective pair of nodes of the plurality of nodes connected by a respective edge of the plurality of edges; generate a plurality of node embeddings comprising a node embedding for each node of the plurality of nodes based on the graph data; generate a matrix based on each positive pair of nodes of the plurality of positive pairs of nodes and the plurality of node embeddings; decompose the matrix to provide a left unitary matrix, a diagonal matrix, and a right unitary matrix; determine a plurality of updated node embeddings comprising an updated node embedding for each node of the plurality of nodes based on the left unitary matrix and the diagonal matrix; and communicate the plurality of updated node embeddings for inputting into at least one machine learning model to generate at least one prediction.
Clause 18: The computer program product of clause 17, wherein the one or more instructions that cause the at least one processor to generate the plurality of node embeddings, cause the at least one processor to: determine a plurality of initial node embeddings comprising an initial node embedding for each node of the plurality of nodes based on the graph data; and train at least one graph neural network based on the plurality of initial node embeddings to provide at least one set of node embeddings, wherein the plurality of node embeddings comprises a set of node embeddings of the at least one set of node embeddings.
Clause 19: The computer program product of clause 17 or clause 18, wherein the at least one graph neural network comprises at least one hidden layer graph neural network and at least one final layer graph neural network, and wherein the one or more instructions that cause the at least one processor to train the at least one graph neural network, cause the at least one processor to: train the at least one hidden layer graph neural network based on the plurality of initial node embeddings to provide at least one set of hidden layer node embeddings; and train the at least one final layer graph neural network based on the at least one set of hidden layer node embeddings to provide a set of final layer node embeddings, wherein the set of node embeddings comprises the set of final layer node embeddings.
Clause 20: The computer program product of any of clauses 17-19, wherein the graph comprises a plurality of negative pairs of nodes, wherein each respective negative pair of nodes comprises a respective pair of nodes of the plurality of nodes that are not connected by an edge of the plurality of edges, and wherein the one or more instructions that cause the at least one processor to generate the matrix, cause the at least one processor to: generate the matrix based on each positive pair of nodes of the plurality of positive pairs of nodes, each negative pair of nodes of the plurality of negative pairs of nodes, and the plurality of node embeddings.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter.

### BRIEF DESCRIPTION OF THE DRAWINGS

Additional advantages and details of the disclosure are explained in greater detail below with reference to the non-limiting, exemplary embodiments that are illustrated in the accompanying schematic figures, in which:

FIG. 1 is a diagram of a non-limiting embodiment or aspect of an environment in which systems, devices, products, apparatus, and/or methods, described herein, may be implemented, according to the principles of the present disclosure;

FIG. 2 is a diagram of one or more components, devices, and/or systems, according to some non-limiting embodiments or aspects;

FIG. 3 is a flowchart of a method for efficient node embeddings for use in predictive models, according to some non-limiting embodiments or aspects;

FIG. 4 is an illustrative diagram of graph data for use in a method for efficient node embeddings for use in predictive models, according to some non-limiting embodiments or aspects;

FIG. 5 is an illustrative diagram of graph data for use in a method for efficient node embeddings for use in predictive models, according to some non-limiting embodiments or aspects;

FIG. 6 is an illustrative diagram of graph data for use in a method for efficient node embeddings for use in predictive models, according to some non-limiting embodiments or aspects;

FIG. 7 is an illustrative diagram of positive pairs of nodes in graph data demonstrating a method for efficient node embeddings for use in predictive models, according to some non-limiting embodiments or aspects;

FIG. 8 is an illustrative diagram of positive and negative pairs of nodes in graph data demonstrating a method for efficient node embeddings for use in predictive models, according to some non-limiting embodiments or aspects;

FIG. 9 is an illustrative diagram of a method for efficient node embeddings for use in predictive models, according to some non-limiting embodiments or aspects; and

FIG. 10 is a flow diagram of a method for efficient node embeddings for use in predictive models, according to some non-limiting embodiments or aspects.

### DESCRIPTION

For purposes of the description hereinafter, the terms “upper”, “lower”, “right”, “left”, “vertical”, “horizontal”, “top”, “bottom”, “lateral”, “longitudinal,” and derivatives thereof shall relate to non-limiting embodiments or aspects as they are oriented in the drawing figures. However, it is to be understood that non-limiting embodiments or aspects may assume various alternative variations and step sequences, except where expressly specified to the contrary. It is also to be understood that the specific devices and processes illustrated in the attached drawings, and described in the following specification, are simply exemplary embodiments or aspects. Hence, specific dimensions and other physical characteristics related to the embodiments or aspects disclosed herein are not to be considered as limiting.

It is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments or aspects. Hence, specific dimensions and other physical characteristics related to the embodiments or aspects disclosed herein are not to be considered as limiting.

Some non-limiting embodiments or aspects are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.” Reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

As used herein, the term “system” may refer to one or more computing devices or combinations of computing devices (e.g., processors, servers, client devices, software applications, components of such, and/or the like). Reference to “a device,” “a server,” “a processor,” and/or the like, as used herein, may refer to a previously-recited device, server, or processor that is recited as performing a previous step or function, a different server or processor, and/or a combination of servers and/or processors. For example, as used in the specification and the claims, a first server or a first processor that is recited as performing a first step or a first function may refer to the same or different server or the same or different processor recited as performing a second step or a second function.

As used herein, the term “acquirer institution” may refer to an entity licensed and/or approved by a transaction service provider to originate transactions (e.g., payment transactions) using a payment device associated with the transaction service provider. The transactions the acquirer institution may originate may include payment transactions (e.g., purchases, original credit transactions (OCTs), account funding transactions (AFTs), and/or the like). In some non-limiting embodiments or aspects, an acquirer institution may be a financial institution, such as a bank. As used herein, the term “acquirer system” may refer to one or more computing devices operated by or on behalf of an acquirer institution, such as a server computer executing one or more software applications.

As used herein, the term “account identifier” may include one or more primary account numbers (PANs), tokens, or other identifiers associated with a customer account. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more data structures (e.g., one or more databases, and/or the like) such that they may be used to conduct a transaction without directly using the original account identifier. In some examples, an original account identifier, such as a PAN, may be associated with a plurality of tokens for different individuals or purposes.

As used herein, the terms “client” and “client device” may refer to one or more client-side devices or systems (e.g., remote from a transaction service provider) used to initiate or facilitate a transaction (e.g., a payment transaction). As an example, a “client device” may refer to one or more POS devices used by a merchant, one or more acquirer host computers used by an acquirer, one or more mobile devices used by a user, one or more computing devices used by a payment device provider system, and/or the like. In some non-limiting embodiments or aspects, a client device may be an electronic device configured to communicate with one or more networks and initiate or facilitate transactions. For example, a client device may include one or more computers, portable computers, laptop computers, tablet computers, mobile devices, cellular phones, wearable devices (e.g., watches, glasses, lenses, clothing, and/or the like), PDAs, and/or the like. Moreover, a “client” may also refer to an entity (e.g., a merchant, an acquirer, and/or the like) that owns, utilizes, and/or operates a client device for initiating transactions (e.g., for initiating transactions with a transaction service provider).

As used herein, the terms “electronic wallet” and “electronic wallet application” refer to one or more electronic devices and/or software applications configured to initiate and/or conduct payment transactions. For example, an electronic wallet may include a mobile device executing an electronic wallet application, and may further include server-side software and/or databases for maintaining and providing transaction data to the mobile device. An “electronic wallet provider” may include an entity that provides and/or maintains an electronic wallet for a customer, such as Google Pay®, Android Pay®, Apple Pay®, Samsung Pay®, and/or other like electronic payment systems. In some non-limiting examples, an issuer bank may be an electronic wallet provider.

As used herein, the term “issuer institution” may refer to one or more entities, such as a bank, that provide accounts to customers for conducting transactions (e.g., payment transactions), such as initiating credit and/or debit payments. For example, an issuer institution may provide an account identifier, such as a PAN, to a customer that uniquely identifies one or more accounts associated with that customer. The account identifier may be embodied on a portable financial device, such as a physical financial instrument, e.g., a payment card, and/or may be electronic and used for electronic payments. The term “issuer system” refers to one or more computer devices operated by or on behalf of an issuer institution, such as a server computer executing one or more software applications. For example, an issuer system may include one or more authorization servers for authorizing a transaction.

As used herein, the term “merchant” may refer to an individual or entity that provides goods and/or services, or access to goods and/or services, to customers based on a transaction, such as a payment transaction. The term “merchant” or “merchant system” may also refer to one or more computer systems operated by or on behalf of a merchant, such as a server computer executing one or more software applications.

As used herein, a “point-of-sale (POS) device” may refer to one or more devices, which may be used by a merchant to conduct a transaction (e.g., a payment transaction) and/or process a transaction. For example, a POS device may include one or more client devices. Additionally or alternatively, a POS device may include peripheral devices, card readers, scanning devices (e.g., code scanners), Bluetooth® communication receivers, near-field communication (NFC) receivers, radio frequency identification (RFID) receivers, and/or other contactless transceivers or receivers, contact-based receivers, payment terminals, and/or the like. As used herein, a “point-of-sale (POS) system” may refer to one or more client devices and/or peripheral devices used by a merchant to conduct a transaction. For example, a POS system may include one or more POS devices and/or other like devices that may be used to conduct a payment transaction. In some non-limiting embodiments or aspects, a POS system (e.g., a merchant POS system) may include one or more server computers configured to process online payment transactions through webpages, mobile applications, and/or the like.

As used herein, the term “payment device” may refer to an electronic payment device, a portable financial device, a payment card (e.g., a credit or debit card), a gift card, a smartcard, smart media, a payroll card, a healthcare card, a wristband, a machine-readable medium containing account information, a keychain device or fob, an RFID transponder, a retailer discount or loyalty card, a cellular phone, an electronic wallet mobile application, a PDA, a pager, a security card, a computing device, an access card, a wireless terminal, a transponder, and/or the like. In some non-limiting embodiments or aspects, the payment device may include volatile or non-volatile memory to store information (e.g., an account identifier, a name of the account holder, and/or the like).

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction processing system” may refer to one or more computer systems operated by or on behalf of a transaction service provider, such as a transaction processing server executing one or more software applications. A transaction processing server may include one or more processors and, in some non-limiting embodiments or aspects, may be operated by or on behalf of a transaction service provider.

The systems, methods, and computer program products described herein provide numerous technical advantages in systems for predictive modeling. First, the described methods are able to produce more accurate predictions by extracting hidden relationships in graphical data. The described methods do this, in part, by using node embeddings of graphs (e.g., representing interactions between entities) as input to machine learning models. Furthermore, the embeddings that are input to machine learning models are themselves more accurate because of steps that update node embeddings based on a decomposed matrix (e.g., produced at least partly based on an optimized loss function), which is based on positive and negative pairs of nodes. By accounting for positive and negative pairs of nodes, similar positive pairs of nodes will be drawn closer in the embedding space, and dissimilar negative pairs of nodes will be pushed apart in the embedding space. More accurate embeddings used as inputs and/or more accurate models (e.g., based on those embedding inputs) improve overall system performance, such as by reducing false positive rates in predictions produced from machine learning models. Reduced false positive rates reduce computational waste created by network communications that are triggered from model detections (e.g., fraud mitigation processes triggered from detected fraud). Moreover, network uptime is improved for system participants, since triggered actions to throttle, decline, or restrict network access are reduced for false positive detections.

In some non-limiting embodiments or aspects, the described methods optimize two goals of graph-related predictive models: alignment and uniformity. In a graph with good alignment, nodes with similar properties should be as close together as possible in the embedding space (e.g., keeping together positive pairs of nodes). In a graph with good uniformity, nodes with different properties should be as far away as possible in the embedding space (e.g., distancing negative pairs of nodes). The described methods optimize both alignment and uniformity in graph-based inputs for predictive models through the use of a generated matrix by which updated node embeddings may be determined. The improvements to alignment and uniformity are detectable and measurable as improvements in predictive accuracy of machine learning models that use the improved node embeddings described herein as an input. For example, in comparative tests between machine learning models that did not use the described techniques for updating node embeddings versus machine learning models that did, the machine learning models that did use the described techniques herein exhibited at least a 2.6% performance lift in predictive accuracy (e.g., as measured by metrics associated with false positive rates). In further comparative tests between the presently disclosed methods and known methods of generating node embeddings, the presently disclosed methods took ⅙^{th} the computational time of the Large-Scale Information Network Embedding (LINE) technique, and 1/40^{th} the computational time of the Node2vec technique, while simultaneously providing better performance lift than either known solution. Further technical improvements are provided by the disclosed methods, in that using faster techniques such as matrix generation and decomposition (e.g., SVD) to update embeddings, rather than training a graph neural network (GNN), helps to reduce training time, improve efficiency, and preserve system resources. To that end, this improved speed and preservation of resources is especially important for very large graphs (e.g., with trillions of nodes).

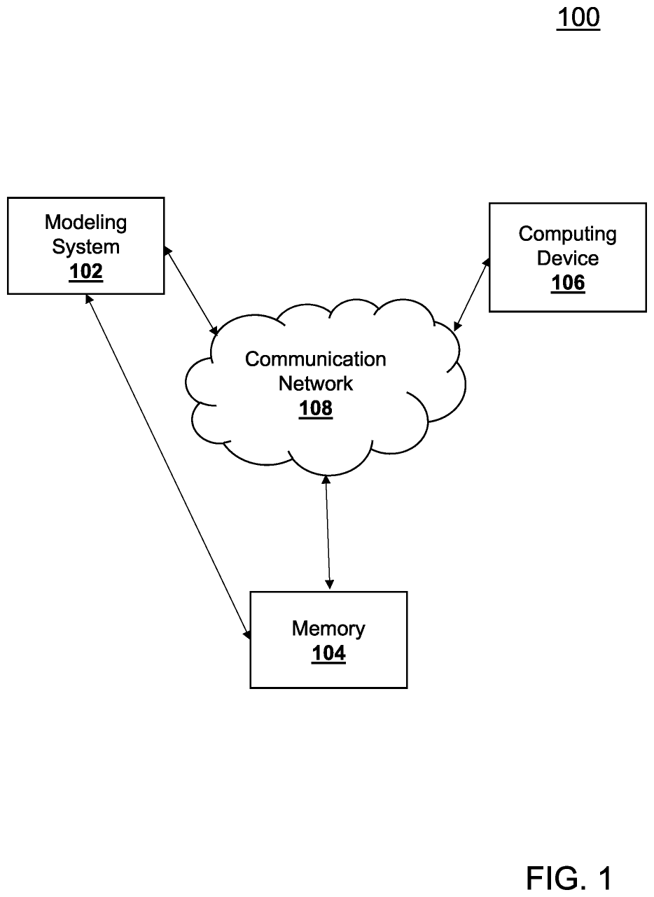

Referring now to FIG. 1, FIG. 1 is a diagram of an example environment 100 in which devices, systems, and/or methods, described herein, may be implemented. As shown in FIG. 1, environment 100 may include modeling system 102, memory 104, computing device 106, and communication network 108. Modeling system 102, memory 104, and computing device 106 may interconnect (e.g., establish a connection to communicate) via wired connections, wireless connections, or a combination of wired and wireless connections. In some non-limiting embodiments or aspects, environment 100 may further include a natural language processing system, an advertising system, a fraud detection system, a transaction processing system, a merchant system, an acquirer system, an issuer system, and/or a payment device.

Modeling system 102 may include one or more computing devices configured to communicate with memory 104 and/or computing device 106 at least partly over communication network 108 (e.g., directly, indirectly via communication network 108, and/or the like). Modeling system 102 may be configured to receive data to train one or more machine learning models, and use one or more trained machine learning models to generate an output. Predictive models may include machine learning models that accept, as input, graph data (or data derived from graph data) to generate one or more predictions (e.g., categorizations, value predictions, etc.). Modeling system 102 may include or be in communication with memory 104. Modeling system 102 may be associated with, or included in a same system as, a transaction processing system.

Memory 104 may include one or more computing devices configured to communicate with modeling system 102 and/or computing device 106 (e.g., directly, indirectly via communication network 108, and/or the like). Memory 104 may be configured to store data associated with graphs, node embeddings, machine learning models, transactions, and/or the like in one or more non-transitory computer-readable storage media. Memory 104 may communicate with and/or be included in modeling system 102.

Computing device 106 may include one or more processors that are configured to communicate with modeling system 102 and/or memory 104 (e.g., directly, indirectly via communication network 108, and/or the like). Computing device 106 may be associated with a user and may include at least one user interface for transmitting data to and receiving data from modeling system 102 and/or memory 104. For example, computing device 106 may show, on a display of computing device 106, one or more outputs of trained machine learning models executed by modeling system 102. By way of further example, one or more inputs for trained sequential machine learning models may be determined or received by modeling system 102 via a user interface of computing device 106.

Communication network 108 may include one or more wired and/or wireless networks over which the systems and devices of environment 100 may communicate. For example, communication network 108 may include a cellular network (e.g., a long-term evolution (LTE®) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN)), a private network, an ad hoc network, an intranet, the Internet, a fiber optic-based network, a cloud computing network, and/or the like, and/or a combination of these or other types of networks.

The number and arrangement of devices and networks shown in FIG. 1 are provided as an example. There may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally or alternatively, a set of devices (e.g., one or more devices) of environment 100 may perform one or more functions described as being performed by another set of devices of environment 100.

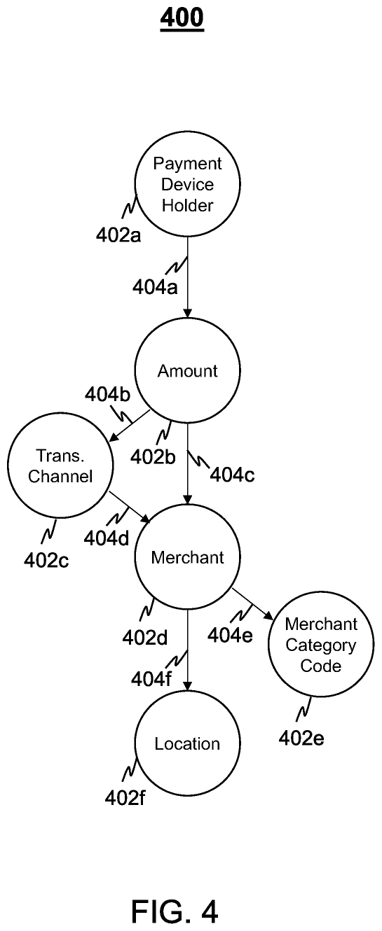

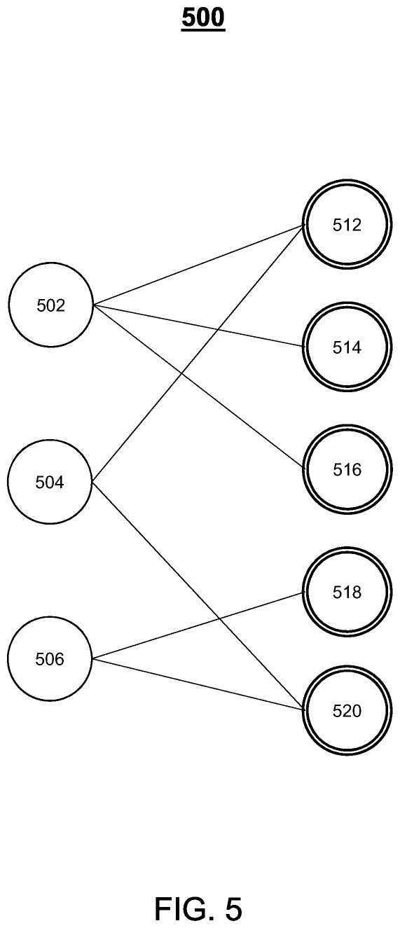

In some non-limiting embodiments or aspects, modeling system 102 may receive graph data associated with a graph. The graph data may include a plurality of nodes and a plurality of edges (see, e.g., FIGS. 4 and 5). Each node of the plurality of nodes may be associated with an entity of a plurality of entities. Each edge of the plurality of edges may be associated with an interaction between at least two entities of the plurality of entities. An entity may be a data representation of, but is not limited to, a user, a data object, a network account, an item, a device, a system, a variable, a data parameter, and/or the like that is capable of having an interaction with (e.g., being in communication with, having a relationship to, being in association with, being related to, having a data mapping to, etc.) other entities in the network. In some non-limiting embodiments or aspects, modeling system 102 may be implemented in an electronic payment processing network, and the types of entities may include, but are not limited to, payment device holder, payment device, transaction account, transaction amount, transaction channel, merchant, transaction location, transaction date, transaction time, merchant category code, and/or the like (see FIG. 4 for further illustration). For example, a graph may have a node associated with a payment device holder entity, which may be linked to a node associated with a transaction amount entity by way of an interaction (e.g., edge), associated with the use of a payment device to complete a transaction. By way of further example, the node associated with the transaction amount entity may be linked to another node associated with a merchant entity by way of an interaction associated with a transaction that was completed with the merchant for the amount. The same node associated with the transaction amount entity may be further linked to a node associated with a transaction channel entity by way of an interaction associated with a transaction for the amount that was made in the channel. The transaction that produces the interaction between the node associated with the payment device holder and the node associated with the transaction amount entity may also produce the interaction between the node associated with the transaction amount entity and the nodes associated with the merchant and the transaction channel.

In some non-limiting embodiments or aspects, the graph may include a plurality of positive pairs of nodes. Each respective positive pair of nodes may include a respective pair of nodes of the plurality of nodes that are connected by a respective edge of the plurality of edges. For example, a positive pair of nodes may include a first node associated with a merchant entity that is linked to a second node associated with a merchant category code entity by way of an edge.

In some non-limiting embodiments or aspects, modeling system 102 may receive graph data associated with graph G=(V, E), where V represents a set of vertices (e.g., nodes) having a dimension of n (e.g., |V|=n), and where E represents a set of edges having a dimension of m (e.g., |E|=m). Modeling system 102 may receive graph data including only graph G (from which adjacency matrix A and degree matrix D may be determined), and/or may receive graph data including adjacency matrix A and/or degree matrix D (e.g., in addition to or in lieu of graph G). Each vertex (also referred to as a “node” herein) of the set of vertices Vin graph G may be connected to one or more other vertices via at least one edge in the set of edges E. The adjacency matrix A may be determined (e.g., by modeling system 102 and/or the like) based on the graph G as follows:

$${A}_{ij} = 1 if {v}_{i} and {v}_{j} has an edge , 0 otherwise \qquad Formula 1$$

where A_{i,j} represents the element at the ith row and the jth column of adjacency matrix A, and vertex vᵢ and vertex vⱼ are the ith and jth vertices, respectively, in the set of vertices V in graph G.

After receiving and/or determining adjacency matrix A, modeling system 102 may determine degree matrix D as D=diag (d₁, . . . , dₙ), where dᵢ is the generalized degree of vertex i. The degree matrix D of an undirected graph G is a diagonal matrix of size n×n that contains information about the degree of each vertex in the set of vertices V, which is the number of edges attached to each vertex. Modeling system 102 determine the Laplacian matrix L of graph G based on degree matrix D and adjacency matrix A by determining the difference of degree matrix D and adjacency matrix A (e.g., L=D−A).

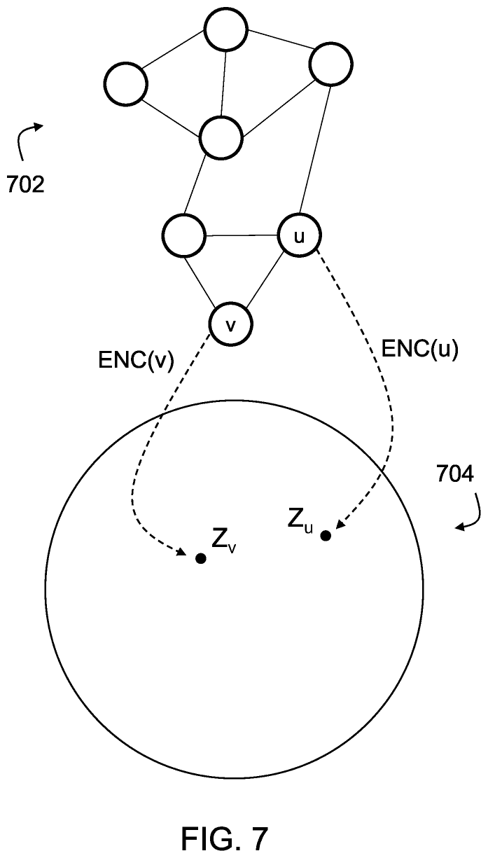

In some non-limiting embodiments or aspects, modeling system 102 may generate a plurality of node embeddings including a node embedding for each node of the plurality of nodes based on the graph data (see, e.g., the illustration of FIG. 7). For example, when generating the plurality of node embeddings, modeling system 102 may generate the plurality of node embeddings based on randomized matrix factorization. By way of further example, when generating the plurality of node embeddings, modeling system 102 may determine a plurality of initial node embeddings including an initial node embedding for each node of the plurality of nodes based on the graph data. The plurality of node embeddings may include the initial node embeddings, which may be an original feature matrices or vectors of each node (e.g., including raw data of neighbor nodes, which are other nodes connected to the node by an edge).

In some non-limiting embodiments or aspects, when generating the plurality of node embeddings, modeling system 102 may determine the plurality of initial node embeddings and train at least one graph neural network based on the plurality of initial node embeddings to provide at least one set of node embeddings. In such a case, the plurality of node embeddings may include a set of node embeddings of the at least one set of node embeddings. The at least one graph neural network may include at least one hidden layer graph neural network and at least one final layer graph neural network. When training the at least one graph neural network, modeling system 102 may train the at least one hidden layer graph neural network based on the plurality of initial node embeddings to provide at least one set of hidden layer node embeddings. When training the at least one graph neural network, modeling system 102 may further train the at least one final layer graph neural network based on the at least one set of hidden layer node embeddings to provide a set of final layer node embeddings. In this manner, the plurality of node embeddings may include a set of node embeddings that includes the set of final layer node embeddings.

In some non-limiting embodiments or aspects, graph G may include a plurality of positive pairs of nodes, wherein each respective positive pair of nodes includes a respective pair of nodes of the plurality of nodes connected by a respective edge of the plurality of edges (see, e.g., the illustration of FIG. 4). Modeling system 102 may generate a matrix based on each positive pair of nodes of a plurality of positive pairs of nodes in the plurality of nodes, each negative pair of nodes of a plurality of negative pairs of nodes in the plurality of nodes, and/or the plurality of node embeddings. The matrix may be based on a partial derivative of a loss function with respect to an embedding of a first node and an embedding of a second node in each positive pair of nodes of the plurality of positive pairs of nodes. To that end, modeling system 102 may optimize a loss function represented as follows:

$$min L = {\sum }_{( i , j ) ∈ A} {p}_{ij} ln σ ( {e}_{i}^{T} {e}_{j} ) + λ {\sum }_{( k , j ) ∉ A} {p}_{kj} ln σ ( - {e}_{k}^{T} {e}_{j} ) \qquad Formula 2$$

where L is the value of the loss function, p_{i,j} represents a first probability value of a connection (e.g., a likelihood of association between vertices based on properties of the vertex embedding vectors) between vertex vᵢ and vertex vⱼ, p_{k,j} represents a second probability value of no connection (e.g., a likelihood of disassociation between vertices based on properties of the vertex embedding vectors) between vertex vₖ and vertex vⱼ, σrepresents the sigmoid function, ln represents the natural logarithmic function (e.g., with a base of number e, i.e., Euler's number), er represents the initial node embedding vector of vertex vᵢ, eⱼ represents the initial node embedding vector of vertex vᵢ, eₖ represents the initial node embedding vector of vertex vₖ, T represents the transpose operator, and λ represents a hyperparameter functioning as a regularization term (e.g., 0.05) that may attenuate (e.g., dampen, lessen) the influence of the second term of the loss function (e.g., the term including the second probability value).

In some non-limiting embodiments or aspects, modeling system 102 may generate the matrix based on a partial derivative of the loss function with respect to an embedding of a first node (e.g., representation node r) and an embedding of a second node (e.g., context node c) in each positive pair of nodes of the plurality of positive pairs of nodes. Modeling system 102 may determine the partial derivative (e.g., gradient of rᵢ^{T}cⱼ)) according to the following formula:

$${M}_{ij} = ln {p}_{ij} {\sum }_{( k , j ) ∉ A} ln λ {p}_{k j} \qquad Formula 3$$

where M_{i,j} represents the matrix having values at position i,j determined as shown above, p_{i,j} represents a first probability value of a connection (e.g., a likelihood of association between vertices based on properties of the vertex embedding vectors) between vertex vᵢ and vertex vⱼ, λ represents a hyperparameter functioning as a regularization term (e.g., 0.05) that may attenuate (e.g., dampen, lessen) the influence of the second probability value, and p_{k,j} represents a second probability value of no connection (e.g., a likelihood of disassociation between vertices based on properties of the vertex embedding vectors) between vertex vₖ and vertex vⱼ. Based on the formulations shown in Formula 2 and Formula 3, modeling system 102 may optimize loss function I by constructing a matrix M for the positive and negative pairs of nodes of the plurality of nodes. Optimization may include decomposing the matrix, based on at least one of an eigendecomposition technique, a native singular value decomposition (SVD) technique, a fast SVD technique, any combination thereof, and/or the like. For example, when using a fast SVD decomposition technique, modeling system 102 may decompose the matrix Mas follows:

$$M = {U}_{d} {\sum }_{d} {V}_{d} \qquad Formula 4$$

where U_{d} is the left unitary matrix, Σ_{d} is the diagonal matrix, and V_{d} is the right unitary matrix.

In some non-limiting embodiments or aspects, modeling system 102 may determine a plurality of updated node embeddings including an updated node embedding for each node of the plurality of nodes based on the left unitary matrix U_{d} and the diagonal matrix Σ_{d}. For example, modeling system 102 may determine each updated node embedding as follows:

$${E}_{a} = {U}_{a} \sqrt{{Σ}_{a}} \qquad Formula 5$$

where E_{d} represents the updated node embedding of size d, and √Σ_{d} represents the square root of the diagonal matrix Σ_{d} associated with U_{d}.

In some non-limiting embodiments or aspects, modeling system 102 may capture high-order proximity through a formulation for higher-order embeddings. For example, modeling system 102 may determine each updated node embedding as follows:

$${E}_{a} = {D}^{- 1} A * L * {E}_{d} \qquad Formula 6$$

where the leftmost E_{d} represents the higher-order node embedding, the rightmost E_{d} represents the updated node embedding, D⁻¹ represents an inverse operation of the degree matrix D, A represents the adjacency matrix, and L represents the Laplacian matrix of adjacency matrix A.

In some non-limiting embodiments or aspects, modeling system 102 may communicate the plurality of updated node embeddings for inputting into at least one machine learning model (e.g., a machine learning model configured to accept, as input, graph-based data) to generate at least one prediction. The at least one machine learning model may accept other inputs in addition to the updated node embeddings, including, but not limited to, features extracted from transactional records.

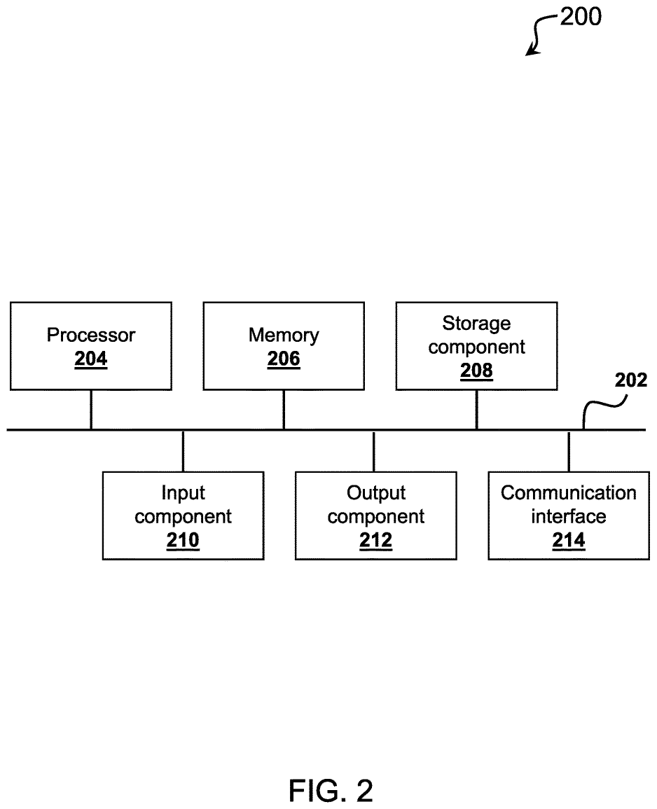

Referring now to FIG. 2, FIG. 2 is a diagram of example components of a device 200, according to some non-limiting embodiments or aspects. Device 200 may correspond to one or more devices of modeling system 102, memory 104, computing device 106, and/or communication network 108, as an example. In some non-limiting embodiments or aspects, such systems or devices may include at least one device 200 and/or at least one component of device 200. The number and arrangement of components shown are provided as an example. In some non-limiting embodiments, device 200 may include additional components, fewer components, different components, or differently arranged components than those shown. Additionally, or alternatively, a set of components (e.g., one or more components) of device 200 may perform one or more functions described as being performed by another set of components of device 200.

As shown in FIG. 2, device 200 may include bus 202, processor 204, memory 206, storage component 208, input component 210, output component 212, and communication interface 214. Bus 202 may include a component that permits communication among the components of device 200. In some non-limiting embodiments or aspects, processor 204 may be implemented in hardware, firmware, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 206 may include random access memory (RAM), read only memory (ROM), and/or another type of dynamic or static storage device (e.g., flash memory, magnetic memory, optical memory, etc.) that stores information and/or instructions for use by processor 204.

With continued reference to FIG. 2, storage component 208 may store information and/or software related to the operation and use of device 200. For example, storage component 208 may include a hard disk (e.g., a magnetic disk, an optical disk, a magneto-optic disk, a solid-state disk, etc.) and/or another type of computer-readable medium. Input component 210 may include a component that permits device 200 to receive information, such as via user input (e.g., a touch screen display, a keyboard, a keypad, a mouse, a button, a switch, a microphone, etc.). Additionally, or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a speaker, one or more light-emitting diodes (LEDs), etc.). Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium may include any non-transitory memory device. A memory device includes memory space located inside of a single physical storage device or memory space spread across multiple physical storage devices. Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “configured to,” as used herein, may refer to an arrangement of software, device(s), and/or hardware for performing and/or enabling one or more functions (e.g., actions, processes, steps of a process, and/or the like). For example, “a processor configured to” may refer to a processor that executes software instructions (e.g., program code) that cause the processor to perform one or more functions.

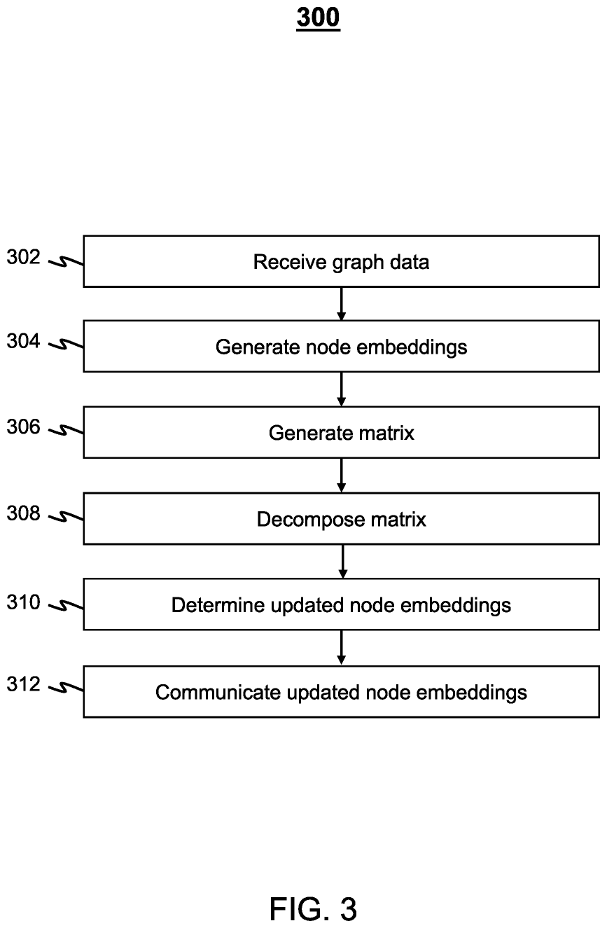

Referring now to FIG. 3, FIG. 3 is a flowchart of a non-limiting embodiment or aspect of a process 300 for efficient node embeddings for use in predictive models, according to some non-limiting embodiments or aspects. The steps shown in FIG. 3 are for example purposes only. It will be appreciated that additional, fewer, different, and/or a different order of steps may be used in non-limiting embodiments or aspects. In some non-limiting embodiments or aspects, one or more of the steps of process 300 may be performed (e.g., completely, partially, and/or the like) by modeling system 102. In some non-limiting embodiments or aspects, one or more of the steps of process 300 may be performed (e.g., completely, partially, and/or the like) by another system, another device, another group of systems, or another group of devices, separate from or including modeling system 102.

As shown in FIG. 3, at step 302, process 300 may include receiving graph data. For example, modeling system 102 may receive graph data associated with a graph including a plurality of nodes and a plurality of edges. Each node of the plurality of nodes may be associated with an entity of a plurality of entities. Each edge of the plurality of edges may be associated with an interaction between at least two entities of the plurality of entities. The graph may include a plurality of positive pairs of nodes, and each respective positive pair of nodes may include a respective pair of nodes connected by a respective edge of the plurality of edges. The graph may further include a plurality of negative pairs of nodes, wherein each respective negative pair of nodes includes a respective pair of nodes of the plurality of nodes that are not connected by a respective edge of the plurality of edges. In some non-limiting embodiments or aspects, modeling system 102 may receive graph data further comprising at least one of an adjacency matrix, a degree matrix, or any combination thereof. Modeling system 102 may further compute the adjacency matrix from the graph data based at least partly on Formula 1, described above, and compute the degree matrix from the adjacency matrix.

As shown in FIG. 3, at step 304, process 300 may include generating a plurality of node embeddings. For example, modeling system 102 may generate a plurality of node embeddings including a node embedding for each node of the plurality of nodes based on the graph data. In some non-limiting embodiments or aspects, modeling system 102 may generate a plurality of node embeddings based on randomized matrix factorization. In some non-limiting embodiments or aspects, modeling system 102 may generate the plurality of node embeddings by determining a plurality of initial node embeddings, including an initial node embedding for each node of the plurality of nodes-which may act as the plurality of node embeddings.

In some non-limiting embodiments or aspects, modeling system 102 may generate the plurality of node embeddings by determining the plurality of initial node embeddings and training at least one graph neural network based on the plurality of initial node embeddings to provide at least one set of node embeddings to act as the plurality of node embeddings. The graph neural network may include at least one hidden layer graph neural network and at least one final layer graph neural network. When training the at least one graph neural network, modeling system 102 may train the at least one hidden layer graph neural network based on the plurality of initial node embeddings to provide at least one set of hidden layer node embeddings, and modeling system 102 may train at least one final layer graph neural network based on the at least one set of hidden layer node embeddings to provide a set of final layer node embeddings, which may act as the plurality of node embeddings.

As shown in FIG. 3, at step 306, process 300 may include generating a matrix. For example, modeling system 102 may generate a matrix based on each positive pair of nodes of the plurality of positive pairs of nodes and the plurality of node embeddings. In some non-limiting embodiments or aspects, modeling system 102 may generate a matrix based on each positive pair of nodes of the plurality of positive pairs of nodes, each negative pair of nodes of the plurality of negative pairs of nodes, and the plurality of node embeddings.

In some non-limiting embodiments or aspects, modeling system 102 may generate the matrix based on each positive pair of nodes of the plurality of positive pairs of nodes based on a first probability value associated with a likelihood of an association between nodes of each positive pair of nodes. Modeling system 102 may further generate the matrix based on each negative pair of nodes of the plurality of negative pairs of nodes based on a second probability value associated with a likelihood of disassociation between nodes of each negative pair of nodes. When generating the matrix based on each negative pair of nodes, modeling system 102 may regularize the second probability value using a hyperparameter that attenuates an influence of the second probability value. Modeling system 102 may further generate the matrix based on a partial derivative of a loss function with respect to an embedding of a first node and an embedding of a second node in each positive pair of nodes of the plurality of positive pairs of nodes. In some non-limiting embodiments or aspects, modeling system 102 may generate the matrix based on Formula 2 and Formula 3, described above.

As shown in FIG. 3, at step 308, process 300 may include decomposing the matrix. For example, modeling system 102 may decompose the matrix to provide a left unitary matrix, a diagonal matrix, and a right unitary matrix. In some non-limiting embodiments or aspects, modeling system 102 may decompose the matrix based on at least one of an eigendecomposition technique, a native singular value decomposition (SVD) technique, a fast SVD technique, any combination thereof, and/or the like. In some non-limiting embodiments or aspects, modeling system 102 may decompose the matrix based on Formula 4, described above.

As shown in FIG. 3, at step 310, process 300 may include determining updated node embeddings. For example, modeling system 102 may determine the plurality of updated node embeddings including an updated node embedding for each node of the plurality of nodes based on the left unitary matrix and the diagonal matrix. In some non-limiting embodiments or aspects, modeling system 102 may determine a plurality of higher-order node embeddings based on an inverse of the degree matrix, the adjacency matrix, a Laplacian matrix of the adjacency matrix, and the updated node embedding (e.g., based on Formula 6, described above).

As shown in FIG. 3, at step 312, process 300 may include communicating the updated node embeddings. For example, modeling system 102 may communicate the plurality of updated node embeddings for inputting into at least one machine learning model to generate at least one prediction. In some non-limiting embodiments or aspects, the at least one machine learning model may be a fraud detection model, and the fraud detection model may be configured to predict, given an input of at least the updated node embeddings (e.g., alone or in combination with other transaction data), whether an entity in the system is engaging in fraudulent transaction behavior, whether a transaction is fraudulent, and/or the like. The at least one prediction may trigger decision-based systems to perform additional actions based on the prediction. For example, in response to a prediction associated with fraud, the generated prediction may trigger at least one fraud mitigation process to be performed by a transaction processing system (e.g., to throttle transactions associated with an entity, to decline transactions associated with an entity, to disable network permissions associated with an entity, etc.).

Referring now to FIG. 4, depicted is an illustrative diagram of graph data for use in a method for efficient node embeddings for use in predictive models, according to some non-limiting embodiments or aspects. In particular, shown is a simplified representation of a graph 400—practical applications of graphs like graph 400 are likely to include many magnitudes more entities and edges, such as billions or trillions of each. The graph 400 includes plurality of nodes 402a-402f, wherein each node 402 of plurality nodes 402a-402f is associated with an entity of a plurality of entities. As shown, graph 400 represents nodes 402 associated with entities in an electronic payment processing network, such as, but not limited to, payment device holder, transaction amount, transaction channel, merchant, merchant category code (MCC), and location. Graph 400 may be useful for producing updated node embeddings that may be used as input in a fraud detection machine learning model.

As shown in FIG. 4, graph 400 further includes plurality of edges 404a-404f. Each edge 404 of the plurality of edges 404a-404f is associated with an interaction between at least two of the plurality of entities. For example, payment device holder node 402a is connected to transaction amount node 402b by edge 404a, which may represent an interaction associated with a transaction for an amount that the payment device holder completed. Transaction amount node 402b is connected to transaction channel node 402c by edge 404b, which may represent an interaction associated with the transaction channel through which the transaction was completed for the amount. Transaction amount node 402b is further connected to merchant node 402d by edge 404c, which may represent an interaction associated with the merchant that received the transaction amount in the transaction. Transaction channel node 402c is connected to merchant node 402d by edge 404d, which may represent an interaction associated with a transaction channel that was used to pay the merchant for the transaction. Merchant node 402d is connected to merchant category code node 402e by edge 404e, which may represent an interaction associated with the merchant belonging to the category of the MCC for the transaction. Merchant 402d is further connected to the location node 402f by edge 404f, which may represent an interaction associated with the merchant being located at the location for the transaction.

Referring now to FIG. 5, depicted is an illustrative diagram of graph data for use in a method for efficient node embeddings for use in predictive models, according to some non-limiting embodiments or aspects. In particular, shown is a graph 500 illustrating how connected graphs capture hidden relationships between nodes and are useful as input for predictive models, particularly if properly embedded. Graph 500 is presented for illustration only and should not be interpreted as limiting. To that end, graph 500 depicts a graphical representation of transaction data of an electronic payment processing network, including a simplified illustration of transaction account nodes 502, 504, 506 interacting with merchant nodes 512, 514, 516, 518, 520.

As shown in FIG. 5, graph 500 includes three nodes 502, 504, 506 that represent transaction account entities: a first node 502 associated with a first transaction account, a second node 504 associated with a second transaction account, and a third node 506 associated with a third transaction account. Graph 500 further includes five nodes 512, 514, 516, 518, 520 associated with merchant entities: first merchant node 512, second merchant node 514, third merchant node 516, fourth merchant node 518, and fifth merchant node 520. The edges connecting the first set of nodes 502, 504, 506 to the second set of nodes 512, 514, 516, 518, 520 are interactions associated with transactions completed between the transaction accounts and the merchants. For example, the first transaction account has completed transactions with the first three merchants, so first transaction account node 502 is connected to first merchant node 512, second merchant node 514, and third merchant node 516, each by an edge. Similarly, the second transaction account has completed transactions with the first and fifth merchants, so second transaction account node 504 is connected to first merchant node 512 and fifth merchant node 520, each by an edge. Lastly, the third transaction account has completed transactions with the fourth and fifth merchants, so third transaction account node 506 is connected to fourth merchant node 518 and fifth merchant node 520, each by an edge. It is from graphs like graph 500 that meaningful relationships can be extracted, through the methods described herein, which may be useful for inputting as updated embeddings to predictive models.

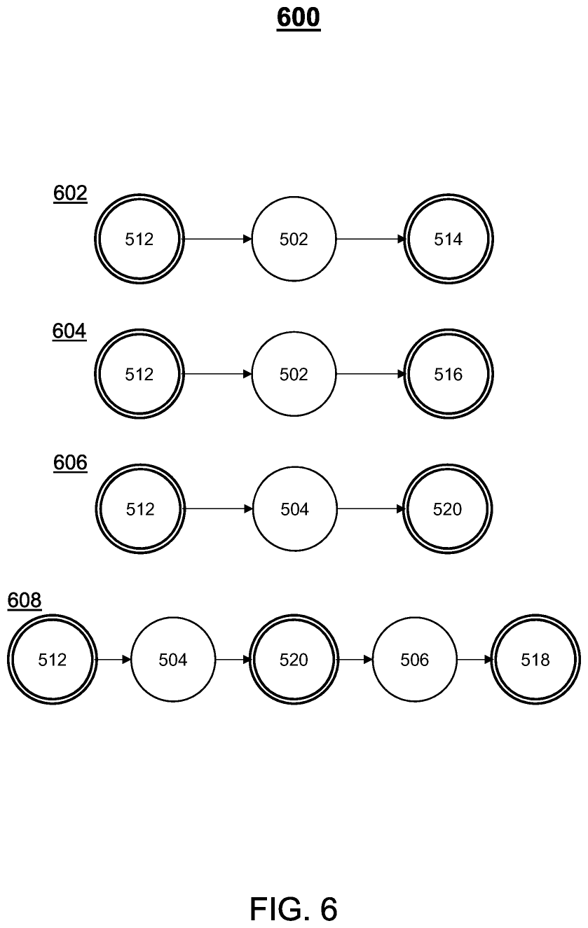

Referring now to FIG. 6, depicted is an illustrative diagram of graph data for use in a method for efficient node embeddings for use in predictive models, according to some non-limiting embodiments or aspects. In particular, shown is a set 600 of subgraphs 602, 604, 606, 608 determined from graph 500 of FIG. 5, illustrating how connected graphs capture hidden relationships between nodes and are useful as input for predictive models, particularly if properly embedded. Graph 600 is presented for illustration only and should not be interpreted as limiting.

As shown in FIG. 6, nodes connected by edges may be said to be related, and two nodes connected by an edge (or edges) may belong to a positive pair. The set 600 of subgraphs 602, 604, 606, 608 demonstrates how edges may indicate relationships between nodes, even where there may not be direct interactions between entities. For example, while there may have not been an immediately obvious connection between the first and second merchant in viewing initial graph 500, first merchant node 512 and second merchant node 514 are connected (shown in subgraph 602) via intermediary first transaction account node 502 associated with a first transaction account. In other words, first transaction account node 502 associated with a first transaction account has edges connected to both first merchant node 512 and second merchant node 514, because of transaction interactions. Accordingly, it may be possible that first merchant node 512 and second merchant node 514 have similar properties because of their connection through first transaction account node 502. Subgraphs 604, 606, 608 are illustrated in similar construction to subgraph 602. Through edgewise connections, subgraph 604 depicts a connective relationship between first merchant node 512, first transaction account node 502 associated with a first transaction account, and third merchant node 516. Likewise, subgraph 606 depicts a connective relationship between first merchant node 512, second transaction account node 502 associated with a second transaction account, and fifth merchant node 520. More distant relationships may be identified through additional hops through graph 500. For example, subgraph 608 depicts a connective relationship between first merchant node 512 and fourth merchant node 518 via second transaction account node 504, fifth merchant node 520, and third transaction account node 506 associated with a third transaction account. These relationships may be provided to predictive modes via updated node embeddings by positively grouping related pairs of nodes (e.g., positive pairs) and distancing unrelated pairs of nodes (e.g., negative pairs), according to described methods herein.

Referring now to FIG. 7, depicted is an illustrative diagram of a method for efficient node embeddings for use in predictive models, according to some non-limiting embodiments or aspects. In particular, illustrated is a simplified illustration of the objectives of producing accurate node embeddings from graphical data. As shown, modeling system 102 may receive graph data of a graph 702 including a plurality of nodes and edges. Two nodes, node u and node v, as described in the methods herein, may be a positive pair of nodes that are likely to have similar properties. Nodes u and v are proximal to one another in the space of graph 702, by virtue of a direct edge connection and a plurality of additional, multi-step paths. It is the objective of an accurate encoding method (represented by the functional abbreviation of ENC( )) that when node u and node v are represented in the embedding space 704 by modeling system 102 (as Zᵥ and Zᵤ), their proximity will approximate the similarity reflected in the original graphical network (graph 702). The more similar node u and node v are, as determined from graph 702, the closer node u and node v should be represented in the embedding space 704, thereby achieving the goal of alignment. Likewise, the less similar node u and node v are, as determined from graph 702, the farther away node u and node v should be represented in the embedding space 704.

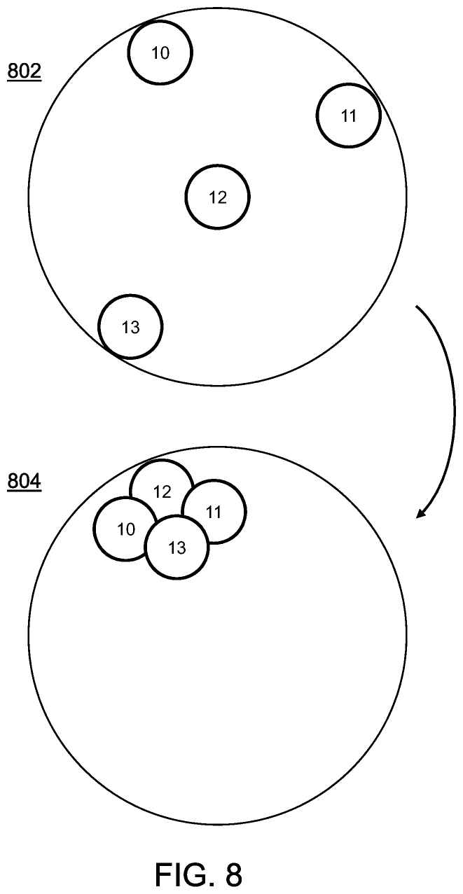

Referring now to FIG. 8, depicted is an illustrative diagram of positive pairs of nodes in graph data, demonstrating a method for efficient node embeddings for use in predictive models, according to some non-limiting embodiments or aspects. In particular, depicted graphically is how the described methods optimize the first goal of alignment, such that nodes with similar properties should be as close as possible in the embedding space. FIG. 8 is presented for a simplified illustration of the present disclosure and should not be interpreted as limiting. In particular, shown is a first embedding space 802 where positive pairs of nodes are not accounted for in node embeddings, and a second embedding space 804 where positive pairs of nodes are accounted for in node embeddings, according to methods described herein. In the first embedding space 802, shown are four node embeddings 10, 11, 12, 13 that are relationally similar and represent at least one (e.g., three to six) positive pairs of nodes. By generating a matrix based on a plurality of positive pairs of nodes, decomposing the matrix, and determining updated node embeddings at least partly from the decomposed matrix, modeling system 102 may determine updated node embeddings where related nodes 10, 11, 12, 13 appear closer together in the first embedding space 802. In this manner, the second embedding space 804 is a better representation of the relatedness of nodes 10, 11, 12, 13, which achieves good alignment, and may produce more accurate predictions when provided as input to machine learning models.

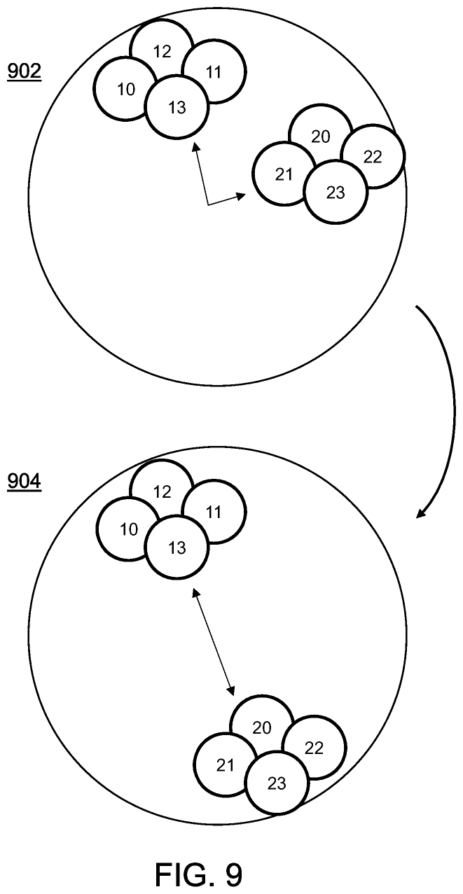

Referring now to FIG. 9, depicted is an illustrative diagram of positive and negative pairs of nodes in graph data, demonstrating a method for efficient node embeddings for use in predictive models, according to some non-limiting embodiments or aspects. In particular, depicted graphically is how the described methods optimize the first goal of alignment and the second goal of uniformity, such that nodes with similar properties should be as close as possible in the embedding space, and nodes with dissimilar properties should be as far away as possible in the embedding space. FIG. 9 is presented for a simplified illustration of the present disclosure and should not be interpreted as limiting. In particular, shown is a first embedding space 902, where positive pairs of nodes are accounted for in node embeddings, but negative pairs of nodes are not accounted for in the node embeddings. Also shown is a second embedding space 904, where both positive pairs of nodes and negative pairs of nodes are accounted for in node embeddings, according to methods described herein. In the first embedding space 902, shown are four node embeddings 10, 11, 12, 13 that are relationally similar and represent at least one (e.g., three to six) positive pairs of nodes. Also shown are four node embeddings 20, 21, 22, 23 that are relationally similar and represent another grouping of positive pairs of nodes. By generating a matrix based on a plurality of positive pairs of nodes, decomposing the matrix, and determining updated node embeddings at least partly from the decomposed matrix, modeling system 102 may determine updated node embeddings where related nodes 10, 11, 12, 13 appear closer together in the first embedding space 902, and related nodes 20, 21, 22, 23 appear closer together in the second embedding space 904. However, in the circumstance where the first group of nodes 10, 11, 12, 13 are dissimilar in properties from the second group of nodes 20, 21, 22, 23, then the first embedding space 902 would not optimize the second goal of uniformity.

As shown in FIG. 9, in the second embedding space 904, modeling system 102 generated a matrix based on a plurality of positive pairs of nodes and a plurality of negative pairs of nodes, decomposed the matrix, and determined updated node embeddings at least partly from the decomposed matrix. In doing so, the dissimilarities between the first group of nodes 10, 11, 12, 13 and the second group of nodes 20, 21, 22, 23 were captured. As such, the first group of nodes 10, 11, 12, 13 are farther away from the second group of nodes 20, 21, 22, 23 in the second embedding space 904 than in the first embedding space 902. In this manner, the second embedding space 904 is a better representation of the dissimilarities of nodes 10, 11, 12, 13 from nodes 20, 21, 22, 23, which achieves good alignment and uniformity, and may produce more accurate predictions when provided as input to machine learning models.

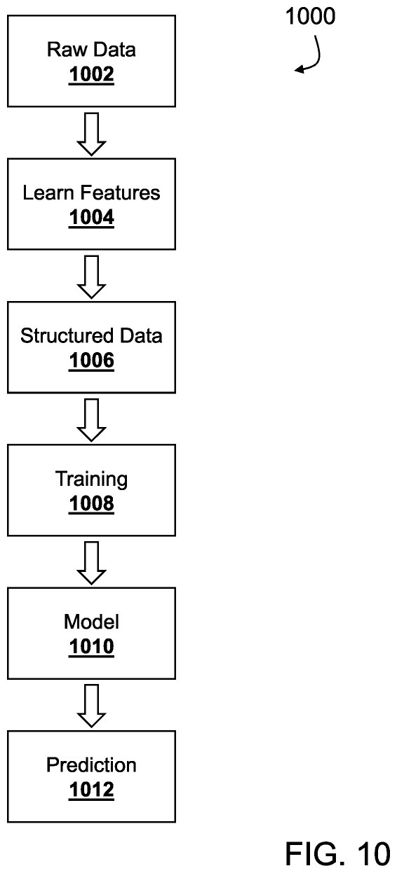

Referring now to FIG. 10, depicted is a flow diagram of a process 1000 for efficient node embeddings for use in predictive models, according to some non-limiting embodiments or aspects. The steps shown in FIG. 10 are for example purposes only. It will be appreciated that additional, fewer, different, and/or a different order of steps may be used in non-limiting embodiments or aspects. Each step of process 1000 may include a series of processes or steps therein. In some non-limiting embodiments or aspects, one or more of the steps of process 1000 may be performed (e.g., completely, partially, and/or the like) by modeling system 102. In some non-limiting embodiments or aspects, one or more of the steps of process 1000 may be performed (e.g., completely, partially, and/or the like) by another system, another device, another group of systems, or another group of devices, separate from or including modeling system 102.

As shown in FIG. 10, at step 1002, process 1000 may include receiving raw data. For example, modeling system 102 may receive raw data related to interactions between entities in a network. In some non-limiting embodiments or aspects, modeling system 102 may retrieve, from memory 104, transaction records including the raw data of interactions between entities in a network. The raw data may include graph data, as depicted and described in FIG. 4.

As shown in FIG. 10, at step 1004, process 1000 may include learning features of the raw data. For example, modeling system 102 may automatically learn, through application of the disclosed methods, relationships in the raw data by, at least partly, (i) generating a plurality of node embeddings of the plurality of nodes, (ii) generating a matrix based on each positive pair of nodes, each negative pair of nodes, and the plurality of node embeddings, and (iii) decomposing the matrix.

As shown in FIG. 10, at step 1006, process 1000 may include generating structured data from the raw data. For example, modeling system 102 may determine a plurality of updated node embeddings based on the decomposed matrix, which was produced at step 1004 to automatically learn the features of the raw data. The structured data may include a more meaningful and accurate set of node embeddings for use as input to predictive machine learning models.

As shown in FIG. 10, at step 1008, process 1000 may include training a predictive machine learning model based on the structured data. For example, modeling system 102 may use the set of updating node embeddings to train a machine learning model to make predictions (e.g., categorizations of entities, relationships of entities, etc.) based on, at least partly, future input of node embeddings of graphical data.

As shown in FIG. 10, at step 1010, process 1000 may include producing a trained machine learning model. For example, modeling system 102 may produce a trained machine learning model based, at least partly, on the updated node embeddings generated in step 1006 and based on the training in step 1008. Modeling system 102 may store the trained machine learning model in memory 104 for use in predictive applications (e.g., fraud detection in an electronic payment processing network).

As shown in FIG. 10, at step 1012, process 1000 may include applying a trained machine learning model to make a prediction. For example, modeling system 102 may retrieve trained machine learning model from memory 104, input a set of new node embeddings from a new set of graph data, and generate one or more predictions based on the input to the trained machine learning model. Based on the predictions in step 1012, further processes may be triggered (e.g., risk mitigation actions, fraud prevention actions, etc.).

Although the present disclosure has been described in detail for the purpose of illustration based on what is currently considered to be the most practical and preferred embodiments or aspects, it is to be understood that such detail is solely for that purpose and that the present disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect, and one or more steps may be taken in a different order than presented in the present disclosure. In fact, any of these features can be combined in ways not specifically recited in the claims and/or disclosed in the specification. Although each dependent claim listed below may directly depend on only one claim, the disclosure of possible implementations includes each dependent claim in combination with every other claim in the claim set.

What is claimed is:

1. A computer-implemented method, comprising:
receiving, with at least one processor, graph data associated with a graph comprising a plurality of nodes and a plurality of edges, each node of the plurality of nodes associated with an entity of a plurality of entities, each edge of the plurality of edges associated with an interaction between at least two of the plurality of entities, the graph comprising a plurality of positive pairs of nodes, each respective positive pair of nodes comprising a respective pair of nodes of the plurality of nodes connected by a respective edge of the plurality of edges;
generating, with at least one processor, a plurality of node embeddings comprising a node embedding for each node of the plurality of nodes based on the graph data;
generating, with at least one processor, a matrix based on each positive pair of nodes of the plurality of positive pairs of nodes and the plurality of node embeddings;
decomposing, with at least one processor, the matrix to provide a left unitary matrix, a diagonal matrix, and a right unitary matrix;
determining, with at least one processor, a plurality of updated node embeddings comprising an updated node embedding for each node of the plurality of nodes based on the left unitary matrix and the diagonal matrix; and
communicating, with at least one processor, the plurality of updated node embeddings for inputting into at least one machine learning model to generate at least one prediction.

2. The method of claim 1, wherein the graph data comprises at least one of an adjacency matrix, a degree matrix, or any combination thereof.

3. The method of claim 1, wherein generating the plurality of node embeddings comprises generating the plurality of node embeddings based on randomized matrix factorization.

4. The method of claim 1, wherein generating the plurality of node embeddings comprises determining a plurality of initial node embeddings comprising an initial node embedding for each node of the plurality of nodes based on the graph data, wherein the plurality of node embeddings comprises the plurality of initial node embeddings.

5. The method of claim 1, wherein generating the plurality of node embeddings comprises:
determining, with at least one processor, a plurality of initial node embeddings comprising an initial node embedding for each node of the plurality of nodes based on the graph data; and
training, with at least one processor, at least one graph neural network based on the plurality of initial node embeddings to provide at least one set of node embeddings,
wherein the plurality of node embeddings comprises a set of node embeddings of the at least one set of node embeddings.

6. The method of claim 5, wherein the at least one graph neural network comprises at least one hidden layer graph neural network and at least one final layer graph neural network, and wherein training the at least one graph neural network comprises:
training, with at least one processor, the at least one hidden layer graph neural network based on the plurality of initial node embeddings to provide at least one set of hidden layer node embeddings; and
training, with at least one processor, the at least one final layer graph neural network based on the at least one set of hidden layer node embeddings to provide a set of final layer node embeddings,
wherein the set of node embeddings comprises the set of final layer node embeddings.

7. The method of claim 1, wherein the graph comprises a plurality of negative pairs of nodes, wherein each respective negative pair of nodes comprises a respective pair of nodes of the plurality of nodes that are not connected by an edge of the plurality of edges, and wherein generating the matrix comprises:
generating, with at least one processor, the matrix based on each positive pair of nodes of the plurality of positive pairs of nodes, each negative pair of nodes of the plurality of negative pairs of nodes, and the plurality of node embeddings.

8. The method of claim 7, wherein generating the matrix comprises:
generating, with at least one processor, the matrix based on each positive pair of nodes of the plurality of positive pairs of nodes based on a first probability value associated with a likelihood of an association between nodes of each positive pair of nodes; and
generating, with at least one processor, the matrix based on each negative pair of nodes of the plurality of negative pairs of nodes based on a second probability value associated with a likelihood of a disassociation between nodes of each negative pair of nodes.

9. The method of claim 8, wherein generating the matrix based on each negative pair of nodes of the plurality of negative pairs of nodes using the second probability value comprises:
regularizing the second probability value using a hyperparameter that attenuates an influence of the second probability value.

10. The method of claim 1, wherein the matrix is based on a partial derivative of a loss function with respect to an embedding of a first node and an embedding of a second node in each positive pair of nodes of the plurality of positive pairs of nodes.

11. The method of claim 1, wherein decomposing the matrix comprises:
decomposing, with at least one processor, the matrix based on at least one of an eigendecomposition technique, a native singular value decomposition (SVD) technique, a fast SVD technique, or any combination thereof.

12. The method of claim 2, further comprising:
determining at least one higher-order node embedding based on an inverse of the degree matrix, the adjacency matrix, a Laplacian matrix of the adjacency matrix, and the updated node embedding for at least one node of the plurality of nodes.

13. A system comprising:
at least one processor configured to:
receive graph data associated with a graph comprising a plurality of nodes and a plurality of edges, each node of the plurality of nodes associated with an entity of a plurality of entities, each edge of the plurality of edges associated with an interaction between at least two of the plurality of entities, the graph comprising a plurality of positive pairs of nodes, each respective positive pair of nodes comprising a respective pair of nodes of the plurality of nodes connected by a respective edge of the plurality of edges;
generate a plurality of node embeddings comprising a node embedding for each node of the plurality of nodes based on the graph data;
generate a matrix based on each positive pair of nodes of the plurality of positive pairs of nodes and the plurality of node embeddings;
decompose the matrix to provide a left unitary matrix, a diagonal matrix, and a right unitary matrix;
determine a plurality of updated node embeddings comprising an updated node embedding for each node of the plurality of nodes based on the left unitary matrix and the diagonal matrix; and
communicate the plurality of updated node embeddings for inputting into at least one machine learning model to generate at least one prediction.

14. The system of claim 13, wherein, when generating the plurality of node embeddings, the at least one processor is configured to:
determine a plurality of initial node embeddings comprising an initial node embedding for each node of the plurality of nodes based on the graph data; and
train at least one graph neural network based on the plurality of initial node embeddings to provide at least one set of node embeddings,
wherein the plurality of node embeddings comprises a set of node embeddings of the at least one set of node embeddings.

15. The system of claim 14, wherein the at least one graph neural network comprises at least one hidden layer graph neural network and at least one final layer graph neural network, and wherein, when training the at least one graph neural network, the at least one processor is configured to:
train the at least one hidden layer graph neural network based on the plurality of initial node embeddings to provide at least one set of hidden layer node embeddings; and
train the at least one final layer graph neural network based on the at least one set of hidden layer node embeddings to provide a set of final layer node embeddings,
wherein the set of node embeddings comprises the set of final layer node embeddings.

16. The system of claim 13, wherein the graph comprises a plurality of negative pairs of nodes, wherein each respective negative pair of nodes comprises a respective pair of nodes of the plurality of nodes that are not connected by an edge of the plurality of edges, and wherein, when generating the matrix, the at least one processor is configured to:
generate the matrix based on each positive pair of nodes of the plurality of positive pairs of nodes, each negative pair of nodes of the plurality of negative pairs of nodes, and the plurality of node embeddings.

17. A computer program product comprising at least one non-transitory computer-readable medium comprising one or more instructions that, when executed by at least one processor, cause the at least one processor to:
receive graph data associated with a graph comprising a plurality of nodes and a plurality of edges, each node of the plurality of nodes associated with an entity of a plurality of entities, each edge of the plurality of edges associated with an interaction between at least two of the plurality of entities, the graph comprising a plurality of positive pairs of nodes, each respective positive pair of nodes comprising a respective pair of nodes of the plurality of nodes connected by a respective edge of the plurality of edges;
generate a plurality of node embeddings comprising a node embedding for each node of the plurality of nodes based on the graph data;
generate a matrix based on each positive pair of nodes of the plurality of positive pairs of nodes and the plurality of node embeddings;
decompose the matrix to provide a left unitary matrix, a diagonal matrix, and a right unitary matrix;
determine a plurality of updated node embeddings comprising an updated node embedding for each node of the plurality of nodes based on the left unitary matrix and the diagonal matrix; and
communicate the plurality of updated node embeddings for inputting into at least one machine learning model to generate at least one prediction.

18. The computer program product of claim 17, wherein the one or more instructions that cause the at least one processor to generate the plurality of node embeddings, cause the at least one processor to:
determine a plurality of initial node embeddings comprising an initial node embedding for each node of the plurality of nodes based on the graph data; and
train at least one graph neural network based on the plurality of initial node embeddings to provide at least one set of node embeddings,
wherein the plurality of node embeddings comprises a set of node embeddings of the at least one set of node embeddings.

19. The computer program product of claim 18, wherein the at least one graph neural network comprises at least one hidden layer graph neural network and at least one final layer graph neural network, and wherein the one or more instructions that cause the at least one processor to train the at least one graph neural network, cause the at least one processor to:
train the at least one hidden layer graph neural network based on the plurality of initial node embeddings to provide at least one set of hidden layer node embeddings; and
train the at least one final layer graph neural network based on the at least one set of hidden layer node embeddings to provide a set of final layer node embeddings,
wherein the set of node embeddings comprises the set of final layer node embeddings.

20. The computer program product of claim 17, wherein the graph comprises a plurality of negative pairs of nodes, wherein each respective negative pair of nodes comprises a respective pair of nodes of the plurality of nodes that are not connected by an edge of the plurality of edges, and wherein the one or more instructions that cause the at least one processor to generate the matrix, cause the at least one processor to:
generate the matrix based on each positive pair of nodes of the plurality of positive pairs of nodes, each negative pair of nodes of the plurality of negative pairs of nodes, and the plurality of node embeddings.
